(19) United States
(12) Patent Application Publication
(10) Pub. No.: US 2025/0019993 A1
(43) Pub. Date: Jan. 16, 2025

(54) COPLANAR HANDLE SYSTEM FOR A LEAF OF A DOOR OR WINDOW, A LEAF SYSTEM FOR A DOOR OR WINDOW AND A METHOD FOR MAKING A LEAF SYSTEM FOR A DOOR OR WINDOW

(71) Applicant: ALBAN GIACOMO S.p.A., Romano d'Ezzelino (IT)

(72) Inventor: Giorgio CESANA, Romano d'Ezzelino (IT)

(21) Appl. No.: 18/670,563

(22) Filed: May 21, 2024

(30) Foreign Application Priority Data
Jul. 11, 2023 (IT) 102023000014517

(51) Int. Cl. E05B 1/00

(52) U.S. Cl. CPC E05B 1/0015; E05B 2001/0023

(57) ABSTRACT

A coplanar handle system for a leaf of a door or window comprises at least one fixed body, installable inside an opening of a leaf, and configured to lie resting against an internal profile of the opening. The handle system also includes at least one movable body hinged to the fixed body and reversibly rotatable with respect to the fixed body between a rest position. The at least one moveable body is substantially flush with the leaf to delimit an internal volume of the opening, and an activation position, in which the at least one moveable body fits into the opening to allow at least partial accessibility to the internal volume.

### CROSS-REFERENCE TO RELATED APPLICATION

The present application claims priority to Italy Patent Application No. 102023000014517, filed on Jul. 11, 2023, and entitled “COPLANAR HANDLE SYSTEM FOR A LEAF OF A DOOR OR WINDOW, A LEAF SYSTEM FOR A DOOR OR WINDOW AND A METHOD FOR MAKING A LEAF SYSTEM FOR A DOOR OR WINDOW,” the disclosure of which is expressly incorporated by reference in its entirety.

### TECHNICAL FIELD

The present disclosure relates to a coplanar handle system for a leaf of a door or window, a leaf system for a door or window and a method for making a leaf system for a door or window. In particular, the present disclosure falls within the technical field of coplanar handles.

### BACKGROUND

A coplanar handle is a type of handle for a door or window which has the peculiarity of being substantially “embedded” in the surface of the leaf so as to be “coplanar,” i.e., flush with the surface of the leaf itself. That is, unlike traditional handles that protrude from the leaf surface, coplanar handles are designed to be integrated into the leaf design, creating a clean appearance without protrusions.

As is known, doors and windows exist which are provided with coplanar handles that allow the leaf to move between an opening condition and a closing condition. Generally, such doors and windows comprise a leaf having a housing inside which the handle is arranged so that it is substantially coplanar with the external surface of the leaf. Disadvantageously, the application of coplanar handles requires the creation of recesses and undercuts inside the leaf in which to nest the handle levers. Such machining results in an increase in assembly time and, therefore, installation costs.

Furthermore, any errors in the creation of the recesses, e.g., during the milling operations, have an impact on the positioning of the handle, very often leading to a misalignment thereof with respect to the leaf surface. Disadvantageously, the large number of elements cooperating with each other to make the handle movement together with the greater narrowness of the housing obtained in the leaf make the correct positioning of the handle with respect to the leaf particularly complicated.

That is, coplanar handles in accordance with the prior art have considerable assembly difficulties.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIGS. 1A-1C illustrate, respectively, a sectional front view, a sectional top view and a partially sectional front view of a coplanar handle system for a leaf of a door or window and of a leaf system for a door or window in accordance with a possible aspect of the present disclosure.

FIG. 1D illustrates a sectional side view of a coplanar handle system for a leaf of a door or window and of a leaf system for a door or window in accordance with a possible aspect of the present disclosure.

FIG. 1E illustrates a detailed view of a portion of the coplanar handle system for a leaf of a door or window and of the leaf system for a door or window shown in FIG. 1D.

FIGS. 2A-2B illustrate, respectively, a sectional front view and a sectional top view of a coplanar handle system for a leaf of a door or window and of a leaf system for a door or window in accordance with a further possible aspect of the present disclosure.

FIGS. 3A-3B illustrate, respectively, a sectional front view and a sectional top view of a coplanar handle system for a leaf of a door or window and of a leaf system for a door or window in accordance with a further possible aspect of the present disclosure.

FIGS. 3C-3E illustrate sectional side views of respective operating positions of the coplanar handle system for a leaf of a door or window and of the leaf system for a door or window shown in FIGS. 3A-3B.

FIGS. 4A-4B are sectional side views of respective operating positions of a further possible aspect of the coplanar handle system for a leaf of a door or window in accordance with the present disclosure.

FIGS. 5A-5C are schematic representations of a method for making a leaf system for a door or window in accordance with a possible aspect of the present disclosure.

### DETAILED DESCRIPTION

An object of the present disclosure is to provide a coplanar handle system for a leaf of a door or window, a leaf system for a door or window, and a method for making a leaf system for a door or window capable of simplifying installation procedures with respect to the prior art.

A further object of the present disclosure is to propose a coplanar handle system for a leaf which is capable of making the opening and closing operations of the door or window easier and more convenient.

Another object of the present disclosure is to provide a coplanar handle system for a leaf of a door or window which ensures an effective locking of the leaf.

The specified objects are substantially achieved by a coplanar handle system for a leaf of a door or window, a leaf system for a door or window, and a method for making a leaf system for a door or window, which comprise the technical features set forth in one or more of the appended claims.

The dependent claims correspond to possible aspects of the disclosure.

With reference to the accompanying drawings, the reference number 1 has been used to generally designate a coplanar handle system for a leaf of a door or window, which will be referred to herein as handle system 1.

The handle system 1 comprises at least one fixed body 2 installable inside an opening “B” of a leaf “A.” In particular, the fixed body 2 is configured to lie resting against an internal profile “P” of the opening “B.”

Preferably, the fixed body 2 has at least one seat 3 adapted to couple to the internal profile “P” of the opening “B” so as to confer increased stability to the handle system 1.

Furthermore, the internal profile “P” ensures the correct positioning of the fixed body 2 inside the opening “B,” facilitating the assembly operations of the handle system 1.

As illustrated in the accompanying drawings, the internal profile “P” can have the conformation of a rib and/or a relief made inside the opening “B.”

In accordance with further possible aspects of the present disclosure, the internal profile “P” can have the conformation of a groove and/or recess made inside the opening “B.”

Purely by way of non-limiting example, the internal profile “P” can be arranged at the centre line of an internal surface of the opening “B.”

In accordance with an aspect, the handle system 1 comprises a movable body 4 hinged to the fixed body 2.

That is, the movable body 4 can be tilting with respect to the fixed body 2.

In particular, the movable body 4 is reversibly rotatable with respect to the fixed body 2 between a rest position, in which it is substantially flush with the leaf “A” to delimit an internal volume “V” of the opening “B,” and an activation position, in which it fits into the opening “B” to allow at least partial accessibility to the internal volume “V.”

Advantageously, the handle system 1 can comprise a recall device 5 active on the movable body 4 to promote the movement thereof from the activation position to the rest position. Thereby, the handle system 1 ensures an effective return of the movable body 4 to the rest position.

For example, the recall device 5 can be active on the movable body 4 so as to promote a return of the movable body 4 and/or of a covering element 11 (as will be described in more detail below) substantially flush with the leaf “A.”

Purely by way of non-limiting example, the recall device 5 can comprise a spring 6, preferably helical.

According to some possible aspects of the present disclosure, the recall device 5 can comprise a pair of magnets (not illustrated in the accompanying drawings) at least partially facing so as to generate a repulsive force adapted to promote the movement of the movable body 4 from the activation position to the rest position.

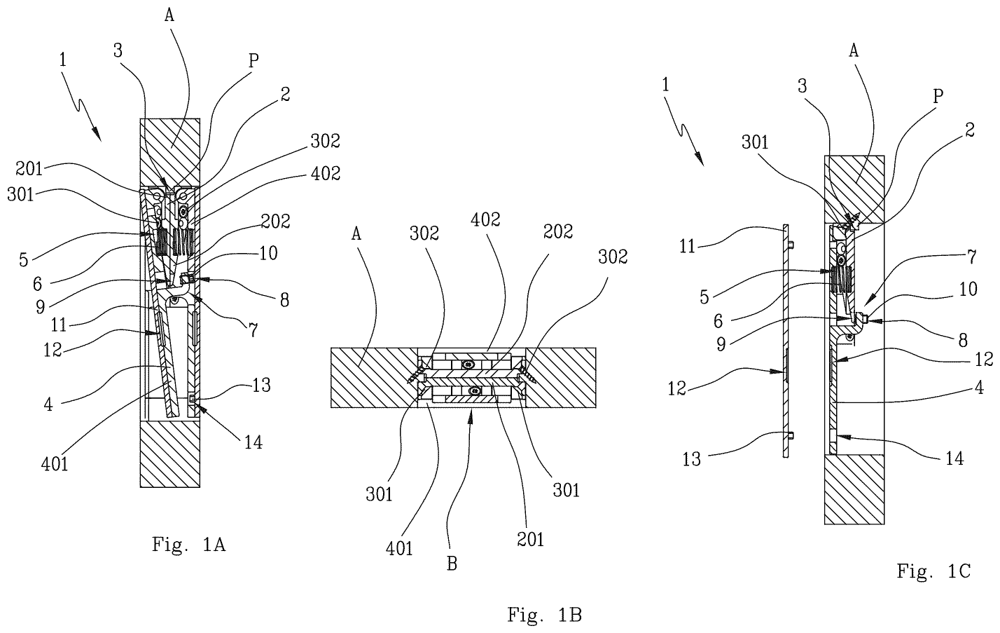

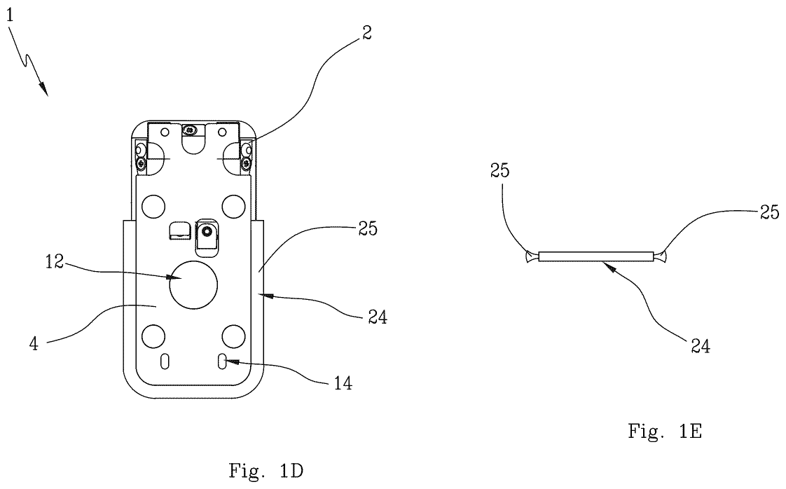

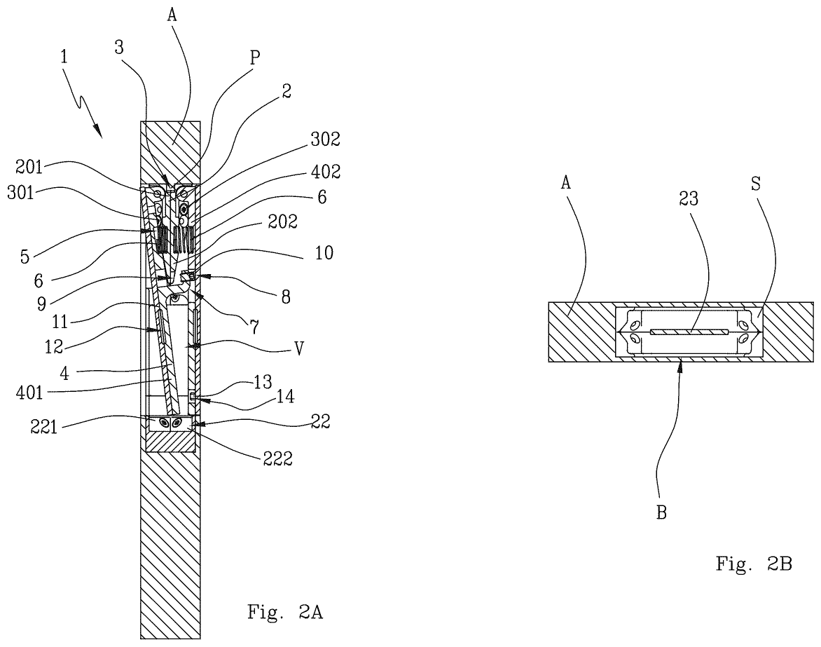

With particular reference to FIGS. 1A, 1C, 2A, 3A, the recall device 5, in particular the spring 6, can act between the fixed body 2 and the movable body 4 to promote the movement of the movable body 4 from the activation position to the rest position.

In accordance with a particularly advantageous aspect, the handle system 1 can comprise a stop 7 defining an end of stroke for the movable body 4 during movement from the activation position to the rest position. Thereby, the handle system 1 ensures an accurate positioning of the movable body 4 with respect to the external surface of the leaf “A.”

With particular reference to FIGS. 1A-1C, the stop 7 can comprise an abutment member 8 adapted to abut on a striking portion 9 of the fixed body 2.

Advantageously, the abutment member 8 and/or the striking portion 9 can comprise a threaded grub screw 10 movable between various stable positions so as to regulate a mutual positioning of the movable body 4 with respect to the fixed body 2 and, therefore, with respect to an external surface of the leaf “A”.

Thereby, the threaded grub screw 10 allows to compensate for any positioning errors and/or machining errors on the leaf by regulating the positioning of the movable body 4 so that, in its rest position, it is flush with the external surface of the leaf “A.”

According to further possible aspects not illustrated in the accompanying drawings, the grub screw can be omitted and the handle system can comprise different types of regulation systems adapted to regulate the positioning of the movable body with respect to the fixed body, without altering the inventive concept underlying the present disclosure.

Advantageously, the handle system 1 can comprise at least one covering element 11 reversibly connectable to the movable body 4 in order to provide the movable body 4 with aesthetic appeal and continuity with the external surface of the leaf “A”.

Purely by way of non-limiting example, the covering element 11 can be made of plastic.

With particular reference to FIG. 1C, the handle system 1 can comprise a magnetic connector 12 for connecting the covering element 11 to the movable body 4.

Additionally or alternatively, the covering element 11 can be at least partially connected to the movable body 4 by gluing, preferably by a double-adhesive element (not illustrated in the accompanying drawings).

Furthermore, or alternatively, the covering element 11 can be at least partially connected to the movable body 4 by a shape coupling.

For example, the covering element 11 can comprise a plurality of protrusions 13 insertable in respective cavities 14 of the movable body 4 to make an at least partial connection between the covering element 11 and the movable body 4.

Advantageously, the handle system 1 can comprise a shade 24 (FIGS. 1D-1E) associated with the movable body 4 and adapted to prevent a passage of light through a gap defined between the movable body 4 and the leaf “A” ensuring an increased isolation of light of the two environments between which the door or window is interposed.

For example, the shade 24 can comprise brush bodies 25.

Furthermore, the shade 24 can be at least partly connected to the fixed body 2 and/or to the leaf “A.”

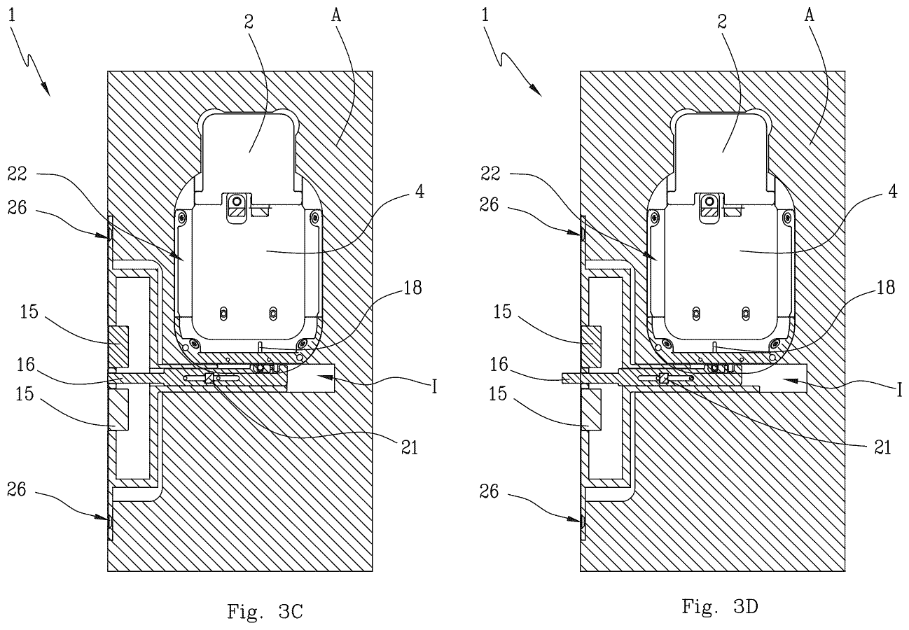

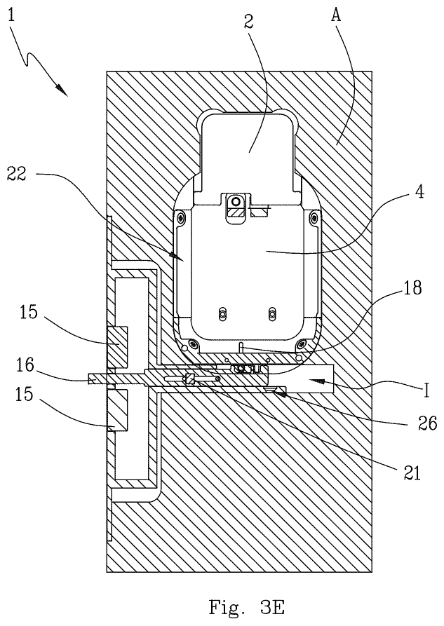

According to a further advantageous aspect of the present disclosure shown in FIGS. 3C-3E, the handle system 1 can comprise a magnetic catch 15 connectable to the leaf “A” and configured to magnetically interact with a counterplate installed on the frame of the door or window, promoting a maintenance of the leaf “A” in a closing condition.

In accordance with a possible aspect of the present disclosure, the handle system 1 can comprise fixing openings 26 adapted to receive a special fixing device for fixing the magnetic catch 15 to the leaf “A.”

Furthermore, the handle system 1 can comprise a locking element 16, for example a bolt, which is reversibly movable between a retracted position, in which it is at least partially housed in a recess “I” of the leaf “A,” and an extracted position, in which it is at least partially protruding from the leaf “A” to define a closing condition of the door or window.

Preferably, the locking element 16 can be movable in translation between the retracted position and the extracted position.

Preferably, the aforementioned fixing openings 26 can be arranged at the recess “I” and, preferably, the fixing device can be introduced in the fixing openings 26 through the opening “B” of the leaf “A.”

Advantageously, the handle system 1 can comprise a retainer 21, preferably of magnetic type, active on the locking element 16 to promote the maintenance of the retracted position and/or the extracted position.

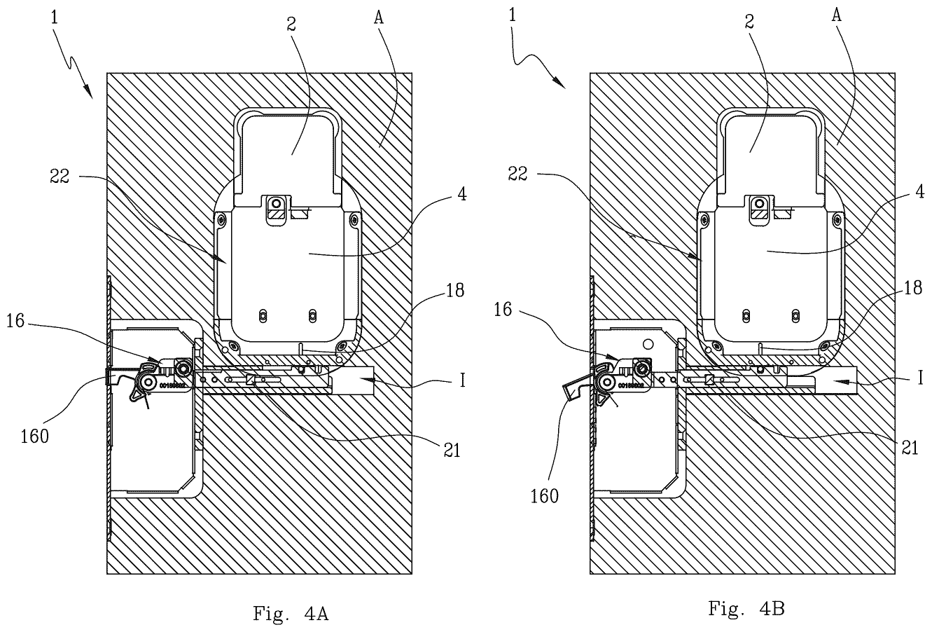

In accordance with a possible aspect illustrated in FIGS. 4A-4B, the locking element 16 can further comprise a rotatable end 160 adapted to hook to a portion of the frame of the door or window ensuring, for example, an effective closing of doors or windows provided with sliding leaves.

With particular reference to FIG. 3B, the handle system 1 can comprise a controller 17 for actuating the locking element 16.

Preferably, the controller 17 is arranged in the internal volume “V.”

Advantageously, the controller 17 can be configured to be arranged, in use, near an edge of the opening “B” of the leaf “A” to be reachable by the internal volume “V.”

Thereby, the controller 17 is substantially nested inside the opening “B” while maintaining the finish and continuity of the external surface of the leaf “A” unaltered.

That is, the controller 17 overcomes the need for further exposed elements on the external surface of the leaf “A,” giving the latter a particular aesthetic appeal.

Preferably, the controller 17 is arranged near a free end of the movable body 4 so that the passage of the movable body 4 from the rest position to the activation position allows accessibility to the controller 17.

With particular reference to FIGS. 3B-3E and 4A-4B, the controller 17 can comprise an actuation member 18 kinematically connected to the locking element 16. In particular, the actuation member 18 can be reachable from the internal volume “V” and activatable by a user to reversibly move the locking element 16 between the retracted position and the extracted position.

Advantageously, the actuation member 18 can be configured so as to be controlled by a user's finger, giving the controller 17 particular convenience.

As shown in the figures, the handle system 1 can comprise a first fixed body 201 and a second fixed body 202 configured to lie resting against the internal profile “P” of the opening “B” and in an opposed position with respect to the aforesaid internal profile “P.” Furthermore, the handle system 1 can comprise a first movable body 401 and a second movable body 402 hinged respectively to the first fixed body 201 and the second fixed body 202. In particular, the first movable body 401 and the second movable body 402 can be at least partially opposed to each other and reversibly movable in mutual approach or distancing between respective rest positions and activation positions.

Preferably, the first fixed body 201 and the second fixed body 202 can be at least partially interposed between the first movable body 401 and the second movable body 402.

Advantageously, the first fixed body 201 and the second fixed body 202 can be substantially identical. Similarly, the first movable body 401 and the second movable body 402 can be essentially identical. Thereby, the present disclosure allows to minimise the number of different manufacturing components while ensuring an efficient production and maintenance process.

Furthermore, the handle system 1 can comprise at least a first screw 301 and at least a second screw 302 adapted to respectively fix the first fixed body 201 and the second fixed body 202 to the leaf “A.” In particular, the first screw 301 and the second screw 302 can be oriented according to askew directions (FIG. 1B), allowing to simplify the assembly procedures of the handle system 1 and ensuring the possibility of an assembly of the handle system 1 on leaves “A” having a particularly narrow thickness.

With particular reference to FIGS. 3A-3B, the controller 17 can comprise a safety member 19 connected to the locking element 16 for reversibly moving it between the retracted position and the extracted position.

In particular, the safety member 19 can be reachable from the internal volume “V.”

Preferably, the safety member 19 can be configured so that it can be controlled by the user by a screwdriver or similar body, for example, having a suitably shaped slit.

In particular, the controller 17 can comprise a plug 20 adapted to kinematically couple the actuation member 18 and the safety member 19.

In more detail, the actuation member 18 and the safety member 19 can be arranged, in use, near a first edge and a second edge, respectively, preferably opposite the first edge, of the opening “B” of the leaf “A.” In particular, the actuation member 18 and the safety member 19 can be arranged respectively near a free end of the first movable body 401 and of the second movable body 402, such that the passage of the first movable body 401 and/or of the second movable body 402 from the rest position to the activation position allows accessibility respectively to the actuation member 18 and/or to the safety member 19.

Thereby, the handle system 1 allows a movement of the locking element 16 from both environments between which the door or window is interposed. Typically, the safety member 19 is positioned on the side of the leaf outside the environment which the door or window is intended to keep closed.

In accordance with an advantageous aspect, the handle system 1 can comprise at least one tray 22 that can be housed in the internal volume “V” and that can be gripped by a user to move the leaf “A,” ensuring greater comfort for the user and increased aesthetic appeal to the entire door or window.

Advantageously, the handle system 1 can comprise at least one spacer 23 housable in the internal volume “V” and configured to define a positioning of the tray 22 in the internal volume “V.”

Thereby, the spacer 23 allows to facilitate the positioning of the tray in the internal volume “V.”

Preferably, the handle system 1 can comprise a plurality of spacers 23 operatively connected to regulate the positioning of the tray 22 in the internal volume “V” so as to adapt the handle system 1 to the thickness of the leaf “A.”

Preferably, the tray 22 is counter-shaped to a countersink “S” peripheral to the opening “B.”

Purely by way of non-limiting example, the movable body 4 can have peripheral edges adapted to come into abutment against the tray 22 when the movable body 4 is in the rest position, so as to shade any passage of light.

In this case, for example, the covering element 11 can advantageously be arranged, when the movable body 4 is in the rest position, substantially flush with the leaf “A.”

Advantageously, the tray 22 can have a modular conformation and comprise a plurality of mutually connectable elements, allowing a simplified insertion in the opening “B” of the leaf “A,” and ensuring a simplification of the assembly procedures of the handle system 1.

For example, the tray 22 can comprise three greater and mutually connectable elements.

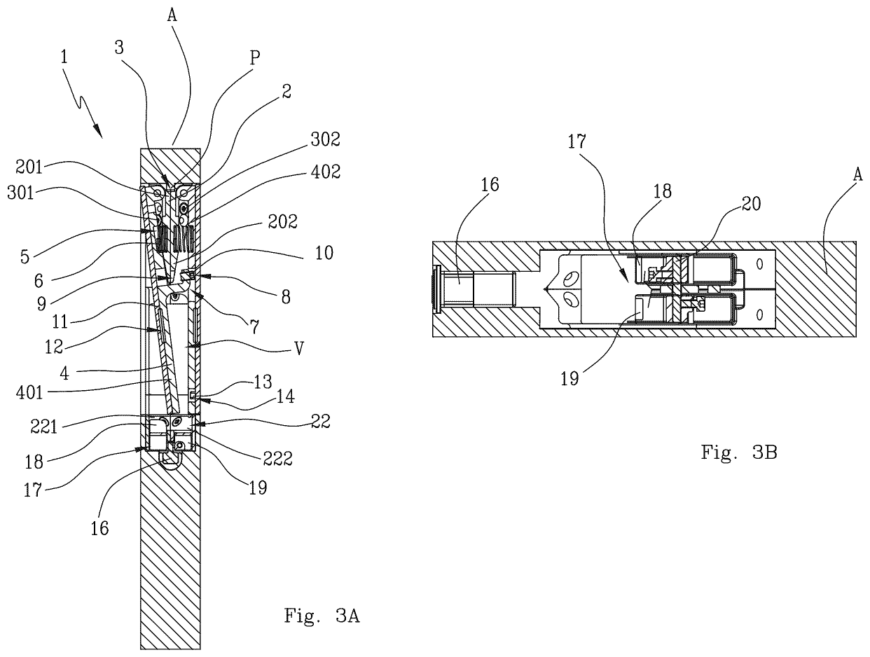

In accordance with some possible aspects of the present disclosure (FIGS. 2A-2B and 3A-3B), the handle system 1 can comprise a first tray 221 and a second tray 222 which are housable in the internal volume “V” at least partially facing each other.

As illustrated in FIG. 2B, between the first tray 221 and the second tray 222 the above-mentioned spacer 23 can be interposed, which can be connected to the leaf “A,” or made on the leaf “A” itself, adapted to define a correct mutual positioning between the first tray 221 and the second tray 222, facilitating the assembly of the handle system 1.

In accordance with a further aspect, the present disclosure refers relates to a leaf system for a door or window.

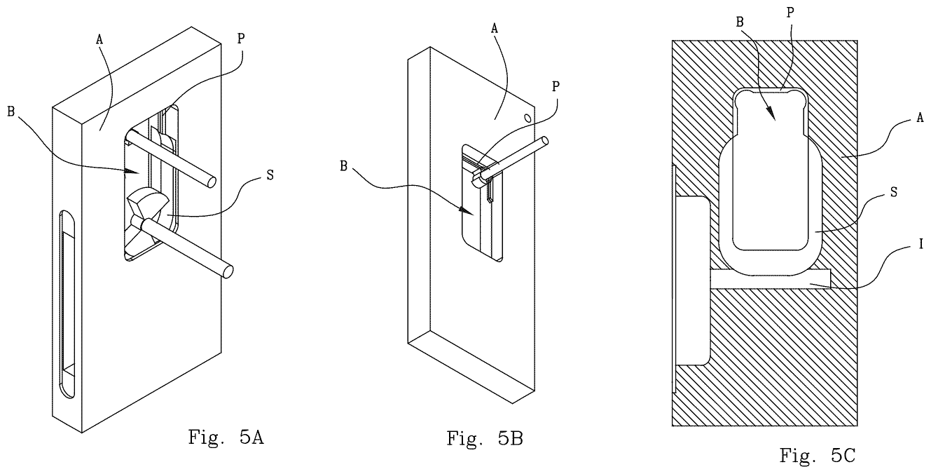

With particular reference to FIGS. 5A-5C, the leaf system comprises a coplanar handle system 1 as described above, and a leaf “A” having an opening “B” adapted to at least partially house the handle system 1.

Preferably, the opening “B” is a through opening for housing a handle system 1 which allows a movement of the leaf “A” from both environments between which the door or window is interposed.

Advantageously, the leaf “A” can have a recess “I” adapted to at least partially house the locking element 16 of the handle system. In particular, the recess “I” can extend along a longitudinal direction and can be in communication with the internal volume “V.”

In accordance with a possible aspect and as illustrated in the accompanying drawings, the leaf “A” can have an internal profile “P” made inside the opening “B” and configured to couple to the fixed body 2 of the handle system 1.

Preferably, the internal profile “P” is arranged at the centre line of the internal surface of the opening “B.”

In accordance with some possible aspects of the present disclosure and as illustrated in the accompanying drawings, the internal profile “P” can be arranged on a top surface of the opening “B” and, preferably, the recess “I” can be obtained below the opening “B.”

According to further possible aspects of the present disclosure not illustrated in the accompanying figures, the internal profile “P” can be arranged on a lower surface of the opening “B” and, preferably, the recess “I” can be obtained above the opening “B.”

Preferably, the leaf “A” has a countersink “S” adapted to at least partially house a tray 22 of the handle system 1.

For example, the countersink “S” can extend peripherally to the opening “B.”

In accordance with a further aspect, the present disclosure also relates to a method for making a leaf system for a door or window comprising the steps of providing a leaf “A” and making an opening “B” on the leaf “A.”

Preferably, the step of making an opening “B” on the leaf “A” involves making a through opening.

As illustrated in FIG. 5B, the method comprises the step of making an internal profile “P” inside the opening.

In particular, the method comprises the steps of providing a coplanar handle system in accordance with what has been previously described and arranging the fixed body 2 resting against the internal profile “P” of the opening “B,” so as to ensure greater stability to the handle system 1.

Preferably, the method can comprise the step of making a recess “I” on the leaf “A” along a longitudinal direction and in communication with the internal volume “V.” In particular, the recess “I” is adapted to at least partially house a locking element 16 of the handle system 1.

As illustrated in FIG. 5C, the recess “I” can be obtained below the opening “B.”

According to further possible aspects not illustrated in the accompanying figures, the recess “I” can be obtained above the opening “B” without the inventive concept underpinning the present disclosure being altered.

Furthermore, the method can comprise the step of making a countersink “S” peripheral to the opening “B.” For example, the peripheral countersink “S” is adapted to at least partially house a tray 22 of the handle system 1.

Preferably, at least one of the steps of the method comprises a sub-step of carrying out a milling on the leaf “A” (FIG. 5A).

The scope of protection is determined by the claims. Nevertheless, the present disclosure can be made in various ways, including those in accordance with the following examples.

Example 1—Coplanar handle system for a leaf of a door or window, the handle system comprises at least one fixed body installable inside an opening of a leaf, the fixed body being configured to lie resting against an internal profile of the opening. The handle system comprises at least one movable body 4 hinged to the fixed body and reversibly rotatable with respect to the fixed body between a rest position, in which it is substantially flush with the leaf to delimit an internal volume of the opening, and an activation position, in which it fits into the opening to allow at least partial accessibility to the internal volume.

Example 2—Handle system according to example 1, wherein the fixed body has at least one seat adapted to couple to the internal profile of the opening.

Example 3—Handle system according to example 1 or 2, comprising recall device active on the movable body to promote the movement thereof from the activation position to the rest position.

Example 4—Handle system according to example 3, wherein the recall device comprises a spring, preferably helical.

Example 5—Handle system according to example 3 or 4, wherein the recall device comprises a pair of at least partially facing magnets with the same opposing polarities in such a way as to generate a repulsive force adapted to promote the movement of the movable body from the activation position to the rest position.

Example 6—Handle system according to one or more of examples 1-5, comprising a stop defining an end of stroke for the movable body during movement from the activation position to the rest position.

Example 7—Handle system according to example 6, wherein the stop comprises an abutment member adapted to abut on a striking portion 9 of the fixed body 2.

Example 8—Handle system according to example 7, wherein the abutment member and/or the striking portion comprise a threaded grub screw movable between various stable positions so as to regulate a mutual positioning of the movable body with respect to the fixed body and, therefore, with respect to an external surface of the leaf.

Example 9—Handle system according to one or more of examples 1-8, comprising at least one covering element reversibly connectable to the movable body.

Example 10—Handle system according to example 9, comprising magnetic connector for connecting the covering element to the movable body.

Example 11—Handle system according to example 9 or 10, wherein the covering element is at least partially connected to the movable body by a shape coupling.

Example 12—Handle system according to example 9 or 11, wherein the covering element is at least partially connected to the movable body by gluing, preferably by a double-adhesive element.

Example 13—Handle system according to one or more of examples 1-12, comprising a shade associated with the movable body and adapted to prevent a passage of light through a gap defined between the movable body 4 and the leaf; preferably the shade comprising brush bodies.

Example 14—Handle system according to one or more of examples 1-13, comprising a locking element that is reversibly movable between a retracted position, in which it is at least partially housed in a recess of the leaf, and an extracted position, in which it is at least partially protruding from the leaf to define a closing condition of the door or window. The handle system comprises a controller for actuating the locking element and configured to be arranged, in use, near an edge of the opening of the leaf to be reachable by the internal volume.

Example 15—Handle system according to example 14, wherein the controller is arranged near a free end of the movable body in such a way that the passage of the movable body from the rest position to the activation position allows accessibility to the controller.

Example 16—Handle system according to example 14 or 15, wherein the controller is arranged in the internal volume.

Example 17—Handle system according to one or more of examples 14-16, wherein the controller comprises an actuation member 18 kinematically connected to the locking element, the actuation member being reachable from the internal volume and activatable by a user to reversibly move the locking element between the retracted position and the extracted position; preferably the actuation member is configured such that it is controlled by a user's finger.

Example 18—Handle system according to one or more of examples, comprising a first fixed body and a second fixed body configured to lie resting against the internal profile of the opening and in an opposed position with respect to the internal profile. The handle system further comprises a first movable body and a second movable body which are hinged respectively to the first fixed body and to the second fixed body, the first movable body and the second movable body being at least partially opposed to each other and reversibly movable in mutual approach or distancing between respective rest positions and activation positions.

Example 19—Handle system according to example 18, wherein the first fixed body and the second fixed body are at least partially interposed between the first movable body and the second movable body.

Example 20—Handle system according to example 18 or 19, wherein the first fixed body and the second fixed body are substantially identical; and/or wherein the first movable body and the second movable body are substantially identical.

Example 21—Handle system according to one or more of examples 18-20, comprising at least a first screw and at least a second screw 302 which are adapted to respectively fix the first fixed body and the second fixed body to the leaf; and wherein the first screw and the second screw are oriented according to askew directions.

Example 22—Handle system according to one or more of examples 18-21 when dependent on example 17, wherein the controller comprises a safety member connected to the locking element for reversibly moving the locking element 16 between the retracted position and the extracted position, the safety member being reachable from the internal volume; preferably the safety member is configured so as to be controlled by the user by a screwdriver.

Example 23—Handle system according to example 22, wherein the controller comprises a plug adapted to kinematically couple the actuation member and the safety member.

Example 24—Handle system according to example 22 or 23, wherein the actuation member 18 and the safety member are arranged respectively near a free end of the first movable body and of the second movable body such that the passage of the first movable body from the rest position to the activation position allows accessibility to the actuation member and that the passage of the first movable body from the rest position to the activation position allows accessibility to the safety member.

Example 25—Handle system according to one or more of examples 1-24, comprising at least one tray that can be housed in the internal volume and that can be gripped by a user to move the leaf.

Example 26—Handle system according to example 25, comprising at least one spacer, preferably a plurality of spacers, housable in the internal volume and configured to define a positioning of the tray in the internal volume.

Example 27—Handle system according to example 25 or 26, wherein the tray is counter-shaped to a countersink peripheral to the opening.

Example 28—Handle system according to one or more of examples 25-27, wherein the movable body has peripheral edges adapted to come into abutment against the tray when the movable body 4 is in the rest position so as to shade any passage of light.

Example 29—Handle system according to one or more of examples 25-28 when dependent on one or more of examples 18-24, comprising a first tray and a second tray which are housable between them at least partially facing the internal volume.

Example 30—Handle system according to example 29 when dependent on example 26, wherein the at least one spacer is at least partially interposed between the first tray and the second tray to define a mutual positioning thereof.

Example 31—Handle system according to one or more of examples 25-30, wherein the at least one tray has a modular conformation and comprises a plurality of mutually connectable elements.

Example 32—Leaf system for a door or window, said leaf system comprising a coplanar handle system 1 according to one or more of examples 1-31. The leaf system comprises, furthermore, a leaf having an opening adapted to at least partially house the handle system 1.

Example 33—Leaf system according to example 32, wherein the opening is a through opening.

Example 34—Leaf system according to example 32 or 33, wherein the leaf has a recess adapted to at least partially house a locking element of the handle system, the recess extending along a longitudinal direction and being in communication with the internal volume.

Example 35—Leaf system according to one or more of examples 32-34, wherein the leaf has an internal profile arranged internally to the opening and configured to couple to the fixed body of the handle system, preferably the internal profile being arranged at the centre line of an internal surface of the opening.

Example 36—Leaf system according to example 35 when dependent on example 34, wherein the internal profile is arranged on a top surface of said opening; and wherein the recess is obtained, preferably, below said opening.

Example 37—Leaf system according to example 35 when dependent on example 34, wherein the internal profile is arranged on a lower surface of said opening; and wherein said recess is obtained, preferably, above the opening.

Example 38—Leaf system according to one or more of examples 32-37, wherein the leaf has a countersink adapted to at least partially house a tray of the handle system, the countersink extending peripherally to the opening.

Example 39—Method for making a leaf system for a door or window comprising the steps of:-providing a leaf and making an opening on the leaf, preferably said opening being a through opening;-providing a coplanar handle system 1 according to one or more of examples 1-31;-making an internal profile at the opening;-placing the fixed body resting against the internal profile of the opening.

Example 40—Method according to example 39, comprising the step of making a recess on the leaf along a longitudinal direction and in communication with the internal volume, the recess being adapted to at least partially house a locking element of the handle system, preferably wherein the recess is obtained below the opening.

Example 41—Method according to example 39 or 40, comprising the step of making a countersink peripheral to said opening, the peripheral countersink being adapted to at least partially house a tray of the handle system.

It is therefore noted that the present disclosure achieves the proposed objects by making a coplanar handle system for a leaf of a door or window, a leaf for a door or window and a method for making a leaf system of a door or window capable of ensuring a simplification of assembly operations with respect to the prior art thanks to the presence of a movable body hinged to a fixed body to be reversibly moved between the rest position and the activation position.

What is claimed:

1. A coplanar handle system for a leaf of a door or window, said coplanar handle system comprising:
at least one fixed body installable inside an opening of a leaf, said fixed body being configured to lie resting against an internal profile of the opening; and
at least one movable body hinged to the fixed body and reversibly rotatable with respect to said fixed body between a rest position, in which the at least one moveable body is substantially flush with the leaf to delimit an internal volume of the opening, and an activation position, in which the at least one moveable body fits into the opening to allow at least partial accessibility to said internal volume.

2. The coplanar handle system according to claim 1, wherein said fixed body has at least one seat adapted to couple to the internal profile of the opening.

3. The coplanar handle system according to claim 1, further comprising a helical spring, active on said movable body to promote the movement thereof from said activation position to said rest position.

4. The coplanar handle system according to claim 1, further comprising a pair of at least partially facing magnets with the same opposing polarities to generate a repulsive force adapted to promote movement of said movable body from said activation position to said rest position.

5. The coplanar handle system according to claim 1, further comprising:
a stop, defining an end of stroke for said movable body during movement from said activation position to said rest position;
wherein said stop comprises an abutment member adapted to abut on a striking portion of the fixed body; and
wherein said abutment member and/or said striking portion comprise a threaded grub screw movable between various stable positions so as to regulate a mutual positioning of the movable body with respect to the fixed body and, therefore, with respect to an external surface of the leaf.

6. The coplanar handle system according to claim 1, further comprising a shade associated with the movable body and adapted to prevent a passage of light through a gap defined between said movable body and the leaf, said shade comprising brush bodies.

7. The coplanar handle system according to claim 1, further comprising:
a locking element that is reversibly movable between a retracted position, in which the locking element is at least partially housed in a recess of the leaf, and an extracted position, in which the locking element is at least partially protruding from the leaf to define a closing condition of the door or window; and
a controller for actuating the locking element and configured to be arranged, in use, near an edge of the opening of the leaf to be reachable by said internal volume;
wherein said controller is arranged near a free end of the movable body in such a way that the passage of the movable body from the rest position to the activation position allows accessibility to said controller.

8. The coplanar handle system according to claim 7, wherein said controller comprises an actuation member kinematically connected to said locking element, said actuation member being reachable from said internal volume and activatable by a user to reversibly move said locking element between the retracted position and the extracted position, said actuation member configured to be controlled by a user's finger.

9. The coplanar handle system according to claim 1, further comprising:
a first fixed body and a second fixed body configured to lie resting against the internal profile of the opening and in an opposed position with respect to said internal profile; and
a first movable body and a second movable body, which are hinged respectively to the first fixed body and to the second fixed body, said first movable body and said second movable body being at least partially opposed to each other and reversibly movable in mutual approach or distancing between respective rest positions and activation positions.

10. The coplanar handle system according to claim 9, further comprising at least a first screw and at least a second screw adapted to respectively fix the first fixed body and the second fixed body to the leaf, and wherein the first screw and the second screw are oriented according to askew directions.

11. The coplanar handle system according to claim 9, wherein said controller comprises an actuation member kinematically connected to said locking element, said actuation member being reachable from said internal volume and activatable by a user to reversibly move said locking element between the retracted position and the extracted position, said actuation member configured to be controlled by a user's finger; and
wherein said controller comprises a safety member connected to said locking element for reversibly moving said locking element between the retracted position and the extracted position, said safety member being reachable from said internal volume, said safety member being configured to be controlled by the user by a screwdriver.

12. The coplanar handle system according to claim 11, wherein said controller comprises a plug adapted to kinematically couple the actuation member and the safety member.

13. The coplanar handle system according to claim 1, further comprising at least one tray that can be housed in said internal volume and that can be gripped by a user to move the leaf.

14. The coplanar handle system according to claim 13, further comprising:
a first fixed body and a second fixed body configured to lie resting against the internal profile of the opening and in an opposed position with respect to said internal profile;
a first movable body and a second movable body which are hinged respectively to the first fixed body and to the second fixed body, said first movable body and said second movable body being at least partially opposed to each other and reversibly movable in mutual approach or distancing between respective rest positions and activation positions; and
a first tray and a second tray that are housable between the first tray and the second tray at least partially facing said internal volume.

15. The coplanar handle system according to claim 13, wherein said at least one tray has a modular conformation and comprises a plurality of mutually connectable elements.

16. A leaf system for a door or window, said leaf system comprising:
a coplanar handle system comprising:
at least one fixed body installable inside an opening of a leaf, said fixed body being configured to lie resting against an internal profile of the opening; and
at least one movable body hinged to the fixed body and reversibly rotatable with respect to said fixed body between a rest position, in which the at least one moveable body is substantially flush with the leaf to delimit an internal volume of the opening, and an activation position, in which the at least one moveable body fits into the opening to allow at least partial accessibility to said internal volume; and
a leaf having an opening adapted to at least partially house said handle system.

17. The leaf system according to claim 16, wherein said opening is a through opening, and/or wherein said leaf has a recess adapted to at least partially house a locking element of the handle system, said recess extending along a longitudinal direction and being in communication with said internal volume.

18. The leaf system according to claim 17, wherein said leaf has an internal profile arranged internally to the opening and configured to couple to the fixed body of the handle system, said internal profile being arranged at the centre line of an internal surface of the opening.

19. The leaf system according to claim 18, wherein said internal profile is arranged on a top surface of said opening, and wherein said recess is obtained below said opening.

20. The leaf system according to claim 18, wherein said internal profile is arranged on a lower surface of said opening, and wherein said recess is obtained above said opening.
